(19) United States
(12) Patent Application Publication
(10) Pub. No.: US 2024/0389570 A1
(43) Pub. Date: Nov. 28, 2024

(54) AUTONOMOUS ROBOT PLATFORM FOR PEST IDENTIFICATION AND CONTROL

(71) Applicant: TECSOIL AUTOMACAO E SISTEMAS S.A, Aracatuba (BR)

(72) Inventors: Tiago PEREIRA SCARPIN, Aracatuba - SP (BR); Deulis Antonio PELEGRIN JAIME, Aracatuba - SP (BR); Rene GONZALEZ HERNANDEZ, Aracatuba - SP (BR); Elier PELEGRIN HERNANDEZ, Aracatuba - SP (BR); Carlos Manuel ZAYAS BARRERA, Aracatuba - SP (BR); Jed NIE, Guangdong (CN); Fabiano BOHLKE BARZ, Indaiatuba - SP (BR)

(21) Appl. No.: 18/696,645

(22) PCT Filed: Sep. 30, 2022
(86) PCT No.: PCT/BR2022/050385

§ 371 Date: Mar. 28, 2024

(30) Foreign Application Priority Data
Oct. 1, 2021 (BR) BR1020210198168
Sep. 30, 2022 (BR) 1020220198209

(51) Int. Cl. A01M 1/22; A01M 99/00

(52) U.S. Cl. CPC A01M 1/22; A01M 99/00

(57) ABSTRACT

The present invention relates to an autonomous robot platform for autonomously identifying and controlling crop pests, comprising: embedded artificial intelligence navigation and decision-making algorithms for identifying and controlling pests; servers embedded in a horizontal structural base (10); at least two front support elements (20) attached to the horizontal structural base (10), wherein each front support element has means of locomotion (40); at least two rear support elements (30) attached to the horizontal structural base (10), wherein each rear support element has means of locomotion (50); at least one control element (60) with five degrees of freedom, including three degrees of freedom of rotation and two degrees of freedom of translation, with, at least one 360 camera (110) and at least one among the following: a laser device (120) and suction pump (140); at least two lateral depth cameras (70); at least one use signaling device (80); and at least one positioning and locating device at the top of the horizontal structural base (10).

### FIELD OF THE INVENTION

The present invention is based on the use of Autonomous Robot Platforms in agriculture. More specifically, the invention refers to an Autonomous Robot Platform associated with artificial intelligence algorithms for pest identification and control in crops.

### DESCRIPTION OF THE STATE OF THE ART

Despite the existence of a high mechanization level in agricultural processes, there are crop care tasks that are still handled manually. It is noted that crop pest control through pesticides is still quite frequent, accounting for a large portion of agricultural production costs.

It is important to note that reductions in pesticide use lead to increased efficiency, by enhancing productivity, lowering costs and lightening environmental impacts.

Consequently, several techniques have been developed in order to provide a satisfactory solution, bringing together energy efficiency, high productivity, and lighter environmental impacts.

Patent document AU2021101399 discloses an agricultural robot system and a robotized method for harvesting, pruning, felling, weeding, measuring, and managing crops.

The invention specifically describes the use of robotic structures and a computer or artificial intelligence system that can sense and decide before acting on the work object, alerting a human operator wherever intervention is needed, Furthermore to being equipped with: mechanical vision, laser scanning, radar, infrared, ultrasound, and touch or chemical sensing.

The robot initially moves through a field to “map” plant locations, as well as number and size of the fruits, and their approximate positions. Once the map is complete, the robot or server can draw up an action plan to be implemented by the robot. This action plan may include operations and data specifying the agricultural function to be performed with the same facility.

Although the robot runs on autonomous navigation technology, interventions in crops are not performed autonomously, instead depending entirely on decisions made by a human operator.

Patent document ES1260398 discloses an agricultural robot for weed extraction, comprising a weed extraction tool arrayed in the robot structure, activated by a programmable control unit.

The invention also discloses a vision system fitted with cameras connected to a programmable electronic control unit, which directs and controls the movement of the robot structure along the length and width of a crop field.

Furthermore, the document also mentions that the robot can detect and distinguish a plant from a weed, in order to be able to extract the latter with the said tool, thus preserving planted crops.

Although the invention has the characteristic of automated weed removal, such weed removal is performed by a mechanical cutter affixed to the end of an articulated arm attached to the robot's structure. Hence, the robot can perform removals only when quite close to the weeds.

Patent Document CN106561093 addresses a laser weed removal robot, based on a parallel mechanism of four degrees of freedom, which includes a mobile chassis, an image acquisition device, a laser, and a control system.

The robot uses the thermal effect of the laser to remove weeds along crop rows and in areas around crop seedlings, wherein a parallel mechanism of four degrees of freedom performs two-dimensional rotations and two-dimensional movements, compensating for changes in weed positions and laser beams caused by the forward movement of the advance of the chassis, thus keeping the laser beam stationary in relation to the weeds.

Although the invention describes a robot that performs pest control autonomously, this control is limited to pests located underneath the robot, as the control mechanism is installed below the main structure of the robot. Furthermore, the mechanism is parallel to the ground, and this restricts its use to pests that are located above the robot's lower structure.

As may be seen, the state of the art lacks a solution that is able to identify and control pests located on plants at different locations and levels, from a height close to the ground to the height of the robot, or even higher, without having an impact on the crop in the form of damage, including when the plant is in its later stages.

In view of the difficulties found at the state of the art, there is a need to develop a technology that can be used on small, agile, light and energy-efficient autonomous robotic equipment, which can identify and perform pest control at different heights and distances in a completely autonomous manner.

### Purpose of the Invention

One of the objectives of the invention is to provide an alternative to manual labor for pest identification and control in crops, being fully autonomous in terms of both movement and making pest control decisions.

Furthermore, another objective of the invention is to reduce the amount of chemical feedstock used, together with production losses.

Moreover, another purpose of the invention is to provide a tool arrayed on autonomous robot platforms for identifying and controlling crop pests at different locations, heights and distances.

### BRIEF DESCRIPTION OF THE INVENTION

In order to achieve the purposes described above, this invention describes a Robot Platform that moves through crops by georeferencing, using cameras associated with artificial intelligence algorithms for autonomous pest identification and control.

The robot platform is autonomous and autonomously performs pest identification and control in crops, being equipped with embedded artificial intelligence algorithms for navigation and making pest identification and control decisions, with embedded servers and also comprises: a horizontal structural base; at least two front support elements affixed to a horizontal structural base, where each front support element has a means of locomotion; At least two rear support elements are affixed to a horizontal structural base, with each rear support element having a means of locomotion; at least one control element/articulated arm having five degrees of freedom, three degrees of freedom of rotation, and two degrees of freedom of translation, with its outer end comprising at least one 360 camera and at least one among: a laser device and a suction pump; at least two lateral depth cameras; at least one in-use signaling device; and at least one positioning and location device on top of the horizontal structural base.

The autonomous system for identifying pests and diseases in crops operates through the use of several cameras. Some of these cameras are mounted on the control elements, allowing images to be taken of hard-to-reach places, such as on the lower portions of crops, for example, where most pests are generally located.

The images are processed by deep learning-based artificial intelligence algorithms; these algorithms are trained to classify different pests and diseases, allowing adaptation to new pests and diseases whenever necessary. The output information from these algorithms processed through artificial intelligence embedded in the Robot Platform is the image classification, which may autonomously trigger the control laser activation, engaging in pest control without communicating with any external servers.

Then the information is sent in real time to servers located on the platform, which may, in turn, serve as a basis for preparing plant germination, pest, weed, failure, or logical phenomena maps.

### BRIEF DESCRIPTION OF THE DRAWINGS

The present invention will be described in more detail below, referring to the Figures appended hereto which present examples of its embodiment, in a schematic manner and without limiting the inventive scope thereof. The drawings comprise:

FIG. 1 illustrates the left side view of the Robot Platform;

FIG. 2A illustrates the front means of locomotion of the Robot Platform;

FIG. 2B illustrates the chain drive between the engine and the front wheels;

FIG. 2C illustrates the rear means of locomotion of the Robot Platform;

FIG. 2D illustrates the shock absorbers used by the Robot Platform;

FIG. 3A shows details of the Robot Platform control element components;

FIG. 3B shows details of the pest control device and camera installed in the Robot Platform control element;

FIG. 4 illustrates the control element affixed to the platform support element;

FIG. 5 illustrates the solar panels used by the Robot Platform;

FIG. 6 presents a flowchart for the Robot Platform movement; and

FIG. 7 illustrates a flowchart used by the system to identify and control crop pests.

### DETAILED DESCRIPTION OF THE INVENTION

Below is a detailed description of a preferred embodiment of this invention that is merely illustrative and not limiting. Nevertheless, possible additional embodiments of this invention will be clear to a person versed in the art when reading this description, which are still encompassed by the essential and optional characteristics defined below.

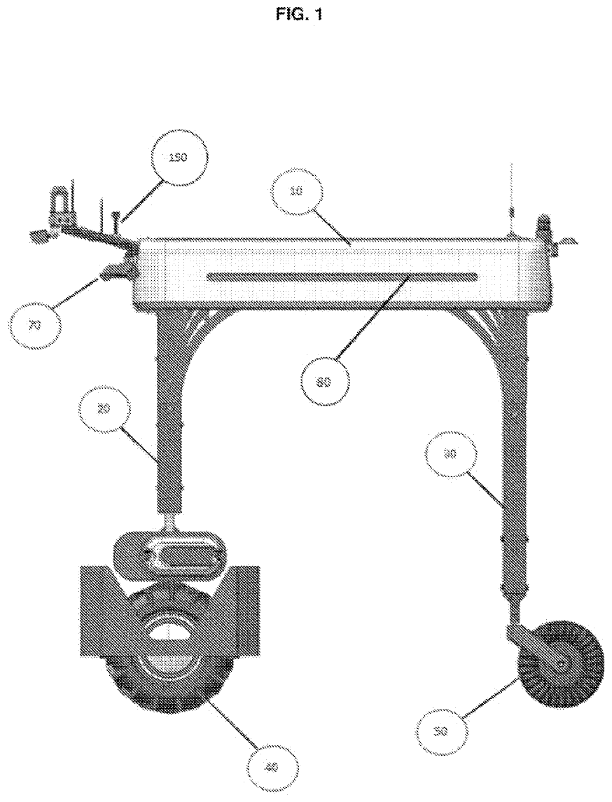

FIG. 1 illustrates the left side view of the Robot Platform used for autonomous crop pest identification and control, whose components are: a horizontal structural base (10), at least two front support elements (20) and at least two support elements (30) affixed to the said horizontal structural base (10), at least one element, which may be a control element, at least two depth-sensing cameras (70) and one in-use signaling device (80).

In one aspect of the Robot Platform, each element of at least two front support elements (20) and each element of at least two rear support elements (30) are provided, respectively, with means of locomotion (40) and (50), wherein such means of locomotion (40) and (50) are preferably wheels.

Furthermore, each element of at least two front support elements (20) and each element of at least two rear support elements (30) has a physical emergency stop button, which switches off power to the engine and prevents movement of the Robot Platform.

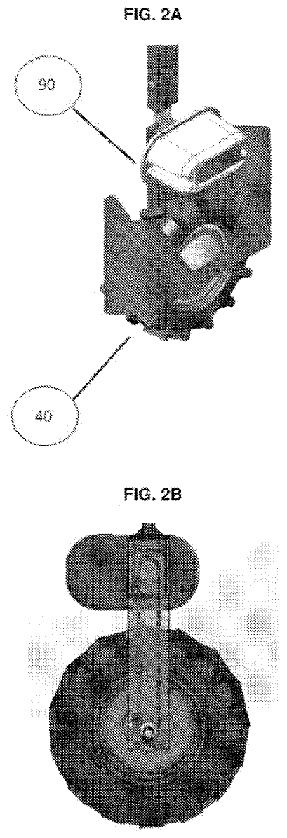

FIG. 2A illustrates the means of locomotion (40), in which in a preferred aspect of the Robot Platform is traction wheels driven by an engine (90) with software-adjustable rotation and, as shown in FIG. 2B, the engine (90) drives the traction wheels through a chain drive system using planetary gear reduction.

As shown in FIG. 2C, the means of locomotion (50) are preferably free-swiveling casters, which are steered by applying different speeds to the traction wheels powered by an engine (90), eliminating lengthy field maneuvers.

Furthermore, in order to keep the traction wheels powered by an engine (90) in intermittent contact with the uneven ground of the field, shock absorbers (100) are fitted to each element of at least two front support elements (20) and each element of at least two rear support elements (30).

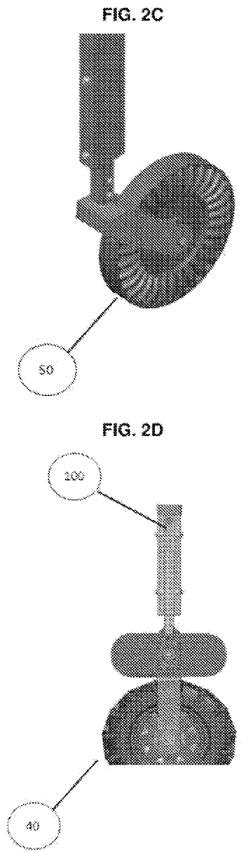

FIG. 3A shows details of at least one control element (60) or articulated arm, affixed to the horizontal structural base (10) with at least five degrees of freedom, comprising at least one 360 camera (110) and at least one pest control laser device (120), as shown in FIG. 3B. FIG. 3B also illustrates a sliding element (61) that can extend into a slider part (62) that comprises a metal bar able to extend the reach of the control element (60), allowing it to reach heights that are higher than the robot, when affixed to a higher part of the robot.

The at least one control element/articulated arm (60) has at least five degrees of freedom, allowing at least one 360 camera (110) to take images in hard-to-reach places, such as the lower portion of the crop that has most pests.

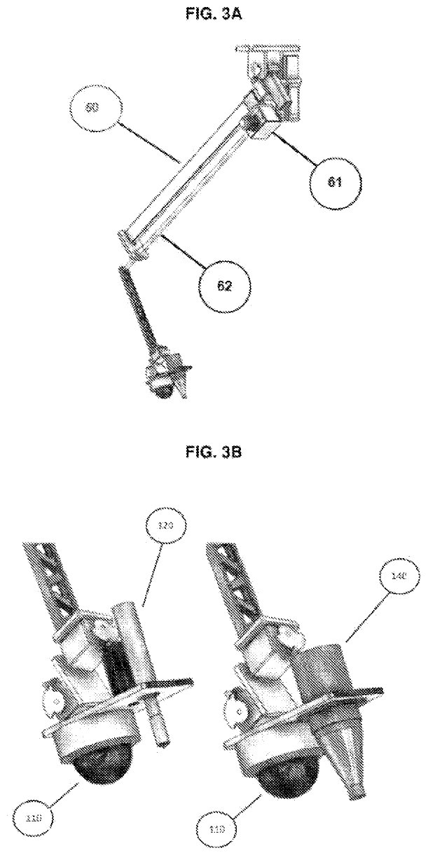

In an embodiment of the invention, as shown in FIG. 4, the control element/articulated arm (60) is installed on the rear support element in order to provide a very broad field of vision and activation in all directions, thus allowing pest identification on the tops, sides, and bottoms of plants for laser application.

The Robot Platform addressed by this invention also has a signaling device (80) that is fitted with position and function indication lights, allowing Robot Platform identification over long distances.

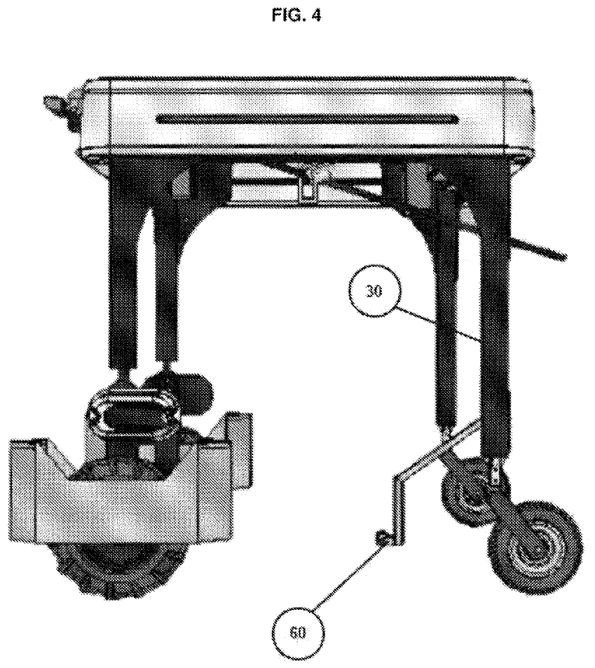

FIG. 5 illustrates at least two solar panels (130) arrayed on top of the horizontal structural base (10), which are the sole sources of power for the Robot Platform. These panels can provide enough power for up to 24 hours of work a day, at an operating speed of preferably 0.4 m/s, with maneuvering speeds of up to 1 m/s.

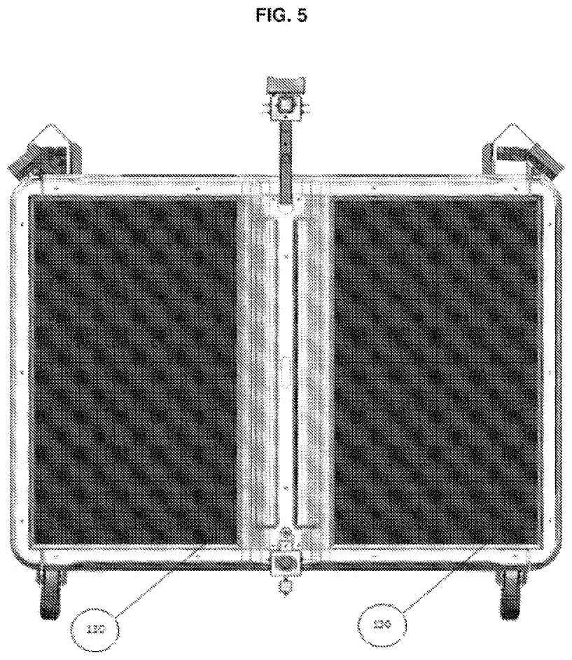

The autonomous locomotion of the Robot Platform, show in detail in FIG. 6 is initially steered by georeferencing, whereby all the commercially available constellations of global positioning satellites may be used, with corrections sent by proprietary Real Time Kinematic (RTK) stations, resulting in accuracy of less than 1.4 cm.

This locomotion is supplemented by the use of depth-sensing cameras (70) mounted on the right and left front ends, allowing navigation to continue even without correction signals from the georeferencing bases, detecting crop lines through proprietary computational vision algorithms and keeping the device between lines to avoid damaging crops. The cameras (70) are also used to detect of obstacles in front of the robot platform, whereby the software activates the emergency stop system whenever something unusual is noticed, switching off the engine and waiting for an autonomous system analysis, with two possible actions: if an obstacle is removed, the robot platform starts moving again after a programmed period, such as 20 seconds, continuing its previous motion prior to the interruption. If an obstacle remains in place, the robot platform swerves to bypass it and then proceeds with the movement planned for the mission.

Furthermore, locomotion is assisted by sensors (150) that determine the slant, acceleration, vibration and magnetic north, helping ensure navigation safety.

Information from the global positioning satellite (GPS) constellation, the proprietary RTK stations, and the depth-sensing cameras are processed through an artificial intelligence algorithm embedded in the Robot Platform, which steers it through the crops.

As the Robot Platform moves through the crops, the images recorded by at least three depth-sensing cameras (70) are processed by a deep learning-based artificial intelligence algorithm, embedded in the Robot Platform and trained to identify different pests and diseases in crops.

The deep learning-based artificial intelligence algorithm autonomously identifies pests, in the forms of eggs, larvae, caterpillars or insects that are already cataloged in its database, and it can also add new records should an unknown pest appear.

Disease identification by the deep learning-based artificial intelligence algorithm examines the upper portion of the plant, and may include its color, vigor and spotting, as already cataloged in a database.

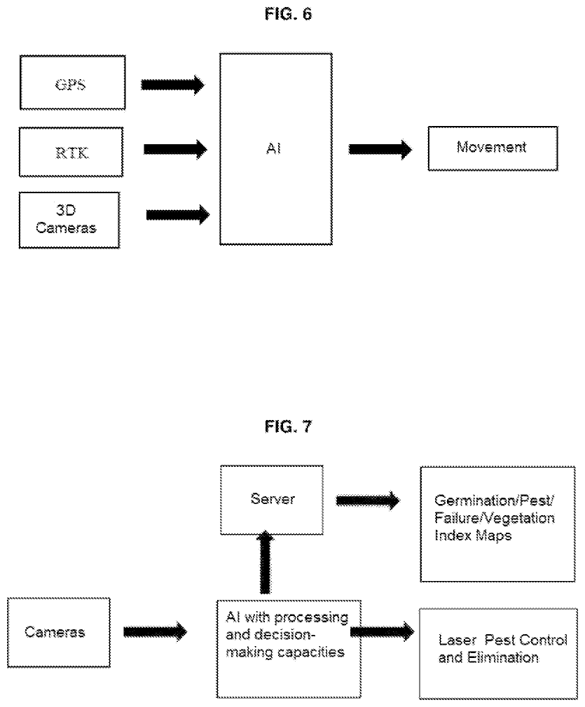

After the identification of pests and diseases by the deep learning-based artificial intelligence algorithm, this information is sent in real time to the server embedded in the Robot Platform, generating crop germination, pest, failure, weed pressure, and phenological stage maps, as shown by the illustration in FIG. 7. This information may also be exported from the robot platform for external use, and may be used in dedicated information technology systems for crop planning, control and management.

After the pest is identified, the deep learning-based artificial intelligence algorithm sends the instruction to the Robot Platform to perform pest control, preferably through at least one pest control laser device (120) affixed to the articulated arm/control element (60).

In another embodiment of the invention, the aforementioned pest control may also be performed by a suction pump (140) arrayed on at least one control element (60), as shown in detail in FIG. 3B.

The power transmission and energy distribution of the Robot Platform may reach efficiency of more than 97%, because its hardware and firmware take measurements through a telemetry sensor in servers with more than ten energy sensors distributed in different Robot Platform modules, providing information on which component is consuming energy.

Furthermore, the server telemetry reads different robot platform function parameters, such as, for example, position, slant, status etc. In all, there are at least fifty parameters that are transmitted to the specific telemetry server, providing real-time robot performance information, as well as possible failures, generating alarms for the operator or manager.

In addition to the telemetry server, it is also possible to connect directly to this system on-site, in order to perform diagnostics at the location of the Robot Platform, through a hardware (cable or wireless) connection to the device boards, where it is possible to check the data and alerts generated.

Transmission of the parameters to the specific telemetry server may be performed through technologies such as 3G/4G/5G, WiFi and XBee, depending on data transmission speed requirements which may vary, depending on the task under way.

The robot platform may be controlled locally or remotely, with near-field control based on a remote control radio, through which it is possible to control the robot platform manually during specific steps, such as transportation. Once the robot is in the field, manual control is normally no longer necessary.

The long-distance remote control allows remote control of the Robot Platform from any location through an internet connection that uses its own encrypted authentication and communication protocol. This feature is advantageous, as it allows remote solutions to any problem, with no need for physical intervention at the actual location of the Robot Platform.

Moreover, the Robot Platform is provided with a safety system integrated with all systems at different levels, depending on where the control is performed. These levels of dependence are defined hierarchically as follows: emergency stop buttons, local remote control, long-distance remote control, and finally its own control algorithm.

Moreover, there is another fully independent system that switches the engine off if the Robot Platform is outside a certain zone. This ensures that if possible operating errors occur, the robot never reaches unwanted places such as roads, for example.

Furthermore, it may be noted that all the metal support structure of the autonomous robot platform are robust and the front (20) and rear (30) support elements are narrow, avoiding plant damage as the platform moves through the crops; it does not compact the soil due to the lightness of its structure; it reaches places that are hard to access on crops; it identifies pests in 100% of the area defined by being powered by electricity sourced from solar panels and batteries.

Additionally, the control element (60) can identify and control pests at different levels from near soil height up to robot height, or even above, with no impacts on crops in the form of damage, even when plants are at their tallest stage.

Finally, the technology disclosed by the invention uses small, agile, light, and energy-efficient automated robotic equipment, performing the same work as undertaken by powerful offroad equipment weighing many tons, while evenly treating dozens of hectares an hour.

It should be noted that the embodiments described in this Specification are intended for clarification, ensuring sufficiency of disclosure for the invention. However, the scope of protection for the invention is demarcated by the Claims.

1. An autonomous robot platform for autonomous crop pest identification and control, the autonomous robot platform comprising:
embedded artificial intelligence algorithms for navigation and decision-making in pest identification and control;
embedded servers;
a horizontal structural base;
at least two front support elements affixed to the horizontal structural base, wherein each of the at least two front support elements has a means of locomotion;
at least two rear support elements affixed to the horizontal structural base, wherein each of the at least two rear support elements has a means of locomotion;
at least one control element endowed with five degrees of freedom, three degrees of freedom of rotation, and two degrees of freedom of translation, comprising a distal end with at least one 360 camera and at least one of: a laser device or a suction pump;
at least two lateral depth cameras;
at least one in-use signaling device; and
at least one positioning and location device on top of the horizontal structural base.

2. The autonomous robot platform according to claim 1, wherein the artificial intelligence algorithm for navigation processes GPS information, RTK base corrections, and images from at least two depth-sensing cameras for the movement of the autonomous robot platform.

3. The autonomous robot platform according to claim 1, wherein the artificial intelligence algorithm for decision-making and pest control is based on deep learning, and is trained to identify pests in the form of eggs, larvae, caterpillars or insects, detect weeds, and identify plant phenological stages.

4. The autonomous robot platform according to claim 1, wherein the means of locomotion are wheels.

5. The autonomous robot platform according to claim 4,
wherein the wheels include front wheels and rear wheels, and
wherein the front wheels are powered, and
wherein the rear wheels are free-swiveling casters.

6. The autonomous robot platform according to claim 5, wherein the front wheels are powered by an engine, through a chain drive system.

7. The autonomous robot platform according to claim 1, wherein each of the at least two front support elements, and each of the at least two rear support elements, are fitted with a shock absorber system.

8. The autonomous robot platform according to claim 1, wherein each of the at least two front support elements, and each of the at least two rear support elements, have an emergency stop button.

9. The autonomous robot platform according to claim 1, wherein at least two solar panels are installed on top of the horizontal structural base.

10. The autonomous robot platform according to claim 1, wherein the autonomous robot platform has an embedded telemetry server that measures at least ten energy sensors.

11. The autonomous robot platform according to claim 10, wherein the autonomous robot platform has an embedded telemetry server that measures parameters to allow real-time failure identification, generating alerts, and alarms.

12. The autonomous robot platform according to claim 10, wherein parameters are transmitted through technologies including at least one of 3G, 4G, 5G, WiFi, or XBee.

13. The autonomous robot platform according to claim 1, wherein the autonomous robot platform is controlled remotely, either near-field or long-distance.

14. The autonomous robot platform according to claim 1, wherein the autonomous robot platform is provided with a security system integrated with all systems of the autonomous robot platform and with different hierarchical control levels.

15. The autonomous robot platform according to claim 1, wherein the autonomous robot platform extends into a sliding portion that comprises a metal bar.
